(19) United States
(12) Patent Application Publication
(10) Pub. No.: US 2022/0287383 A1
(43) Pub. Date: Sep. 15, 2022

(54) Method for Weaning a Child

(71) Applicant: Carla Marie Goncalves, Bangor (GB)

(72) Inventor: Carla Marie Goncalves, Bangor (GB)

(21) Appl. No.: 17/830,297

(22) Filed: Jun. 1, 2022

Related U.S. Application Data
(62) Division of application No. 17/155,261, filed on Jan. 22, 2021.

(51) Int. Cl. A41C 3/04; A41C 3/06

(52) U.S. Cl. CPC A41C 3/04; A41C 3/065

(57) ABSTRACT

The method disclosed herein provides a method for weaning a child by restrict access to mom's breast during the day to reduce or completely stop breastfeeding of children through devices that make nursing unattractive or unavailable to a child, one embodiment uses unattractive nipple coverings, shielding the child from seeing the nipple while at the same time projecting an unattractive image to the child, a second embodiment has a softer image showing the toddler that the breast is unavailable without being unattractive and a third embodiment is a chest wrap that makes the beasts and nipples unavailable to the child.

### FIELD OF THE INVENTION

This disclosed technology relates generally to the field of pacifiers and nipples. In particular, embodiments of the present disclosed technology relate to a method and device for weaning an infant or child from the use of pacifiers or nipples.

### BACKGROUND

There are five main strategies for weaning.

Baby-led weaning: Sometimes a baby stops breastfeeding on his own. However, young infants rarely wean themselves. True self-weaning is usually gradual and happens after a child is a year old.

Gradual weaning: Gradual weaning a slow weaning process. It takes place over weeks, months, or years.

Partial weaning: Partial weaning is a great alternative if you can't breastfeed exclusively but you don't want to give up on breastfeeding altogether.

Sudden weaning: Sudden weaning is the quick end of breastfeeding.

Temporary weaning: Temporary weaning is when breastfeeding is stopped for a short period then restarted. A mother may temporarily wean her child if she has a health issue or needs surgery.

The success of these methods depends on the child, it can could be successful or it could be unsuccessful and very stressful for the parent and child. This method of this application applies when a child is resistant to the main methods of weaning.

### BACKGROUND—PRIOR ART PATENTS

Weaning patents are focused on pacifiers rather than nursing and their main focus is to make the nipple painful or unappealing to the child.

U.S. Pat. No. 4,153,170, Aquarian, puts a straw into a Pacifier nipple, U.S. Pat. No. 6,000,056 Ibegwa, talks about a vest type device with multiple bottles kept warm by the mother's body, US10835350, Khodadai, discloses a method of putting bristles on a pacifier nipple for weaning and patent application 2010006959, Parker, has a method that changes the nipples to smaller and smaller sizes to discourage pacifier use.

Regarding making the mother's nipple unavailable, U.S. Pat. No. 5,966,803, discloses a chest compression wrap that covers up both breasts, and U.S. Pat. No. 8,900,032, Punsal, shows a tight fitting athletic brassier, both which would serve to make the breast unavailable to the child.

### SUMMARY OF THE INVENTION

This product is intended to be used as method to stop breastfeeding babies from four months and toddlers by making nursing unattractive or unavailable to a child, one embodiment uses unattractive nipple coverings, shielding the child from seeing the nipple while at the same time projecting an unattractive image to the child, another embodiment uses softer images such as a mother being asleep or that the nipple is unavailable to the child, a third embodiment is a chest wrap that makes the beasts and nipples unavailable to the child. The method has three embodiments, one embodiment uses unattractive nipple coverings, shielding the child from seeing the nipple while at the same time projecting an unattractive image to the child, a second embodiment has softer images that show the breast and nipple are not available to the child, and a third embodiment is a chest wrap that makes the beasts and nipples unavailable to the child.

The first and second embodiment is a method of using nipple covers for mothers. This product is intended to be used as a method to stop breastfeeding children from 18 months onwards. The nipple covers cover the nipple, the areola around the nipple and part of the breast. The covers can have a design which will show abnormal colors/shape of the mother's nipple, or softer images that show that the breast is unavailable.

The cover will be sticky on one of its surfaces, they are washable and intended to be applied on the top of the mother's nipple to change its appearance and discourage the toddler/child from reaching to the breast to nurse. The aim is that toddler/young child finds the mom's breast no longer appealing and ends up rejecting it!

The covers are made with child safe approved materials (e.g. using BPA free silicone and nontoxic coloring of the nipple), there will be three skin tones (pale nude, tan and brown as it is important for the cover to blend with the mom's skin color as much as possible.

This method may also incorporate blending components from a stick, jar or other that can make the nipple cover blend into the skin. This is to help disguise the fact that the nipple cover is an added-on and to help prevent the child from wanting to tear off the nipple cover.

The third embodiment, the band can be used to restrict access to mom's breast during the day (to reduce or completely stop breastfeeding of babies, most effective between 4-18 months) or during the night (used to reduce number feeds or stop night breast feeding all together for babies and toddlers of any age) it applies to co-sleepers and children who don't co-sleep. It can also be used as a method to stop babies and toddlers from using mom's breast as method to fall asleep.

This product is comprised by an elastic and resistant band of fabric used by mothers to cover their breast and thus restrict the baby/toddler's access to a mother's breast.

Band closures with Velcro can be used directly in contact with skin breast or used on top of the bra, can be used during the day or to sleep with. The band should be available in multiple sizes S/M and M/L and in three colors (white, nude and black).

### BRIEF DESCRIPTION OF DRAWINGS

FIG. 1 shows the breast wrap as it would sit on a mother holding a child.

FIG. 2 is a side view of the nipple cover with images on a mother.

FIG. 3 is a front view of the nipple cover with images on a mother.

FIG. 4 is a view of the nipple cover.

### PART NUMBER DESCRIPTION

1. Breast Wrap
2. Nipple Cover
3. Blending Area
4. Unappealing/discouraging/abnormal or softer images

### DETAILED DESCRIPTION

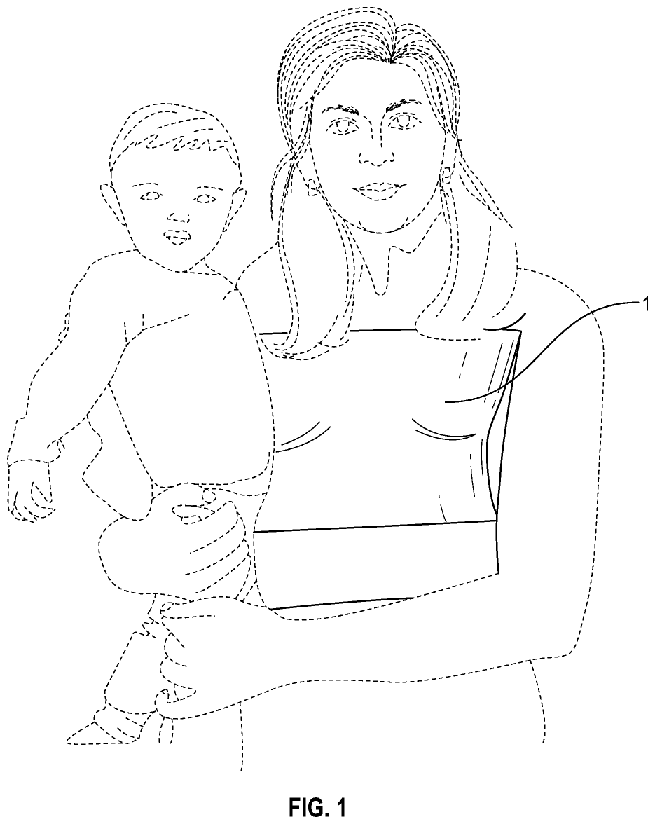

FIG. 1 shows the breast wrap 1 that makes the mother's nipples unavailable to her child.

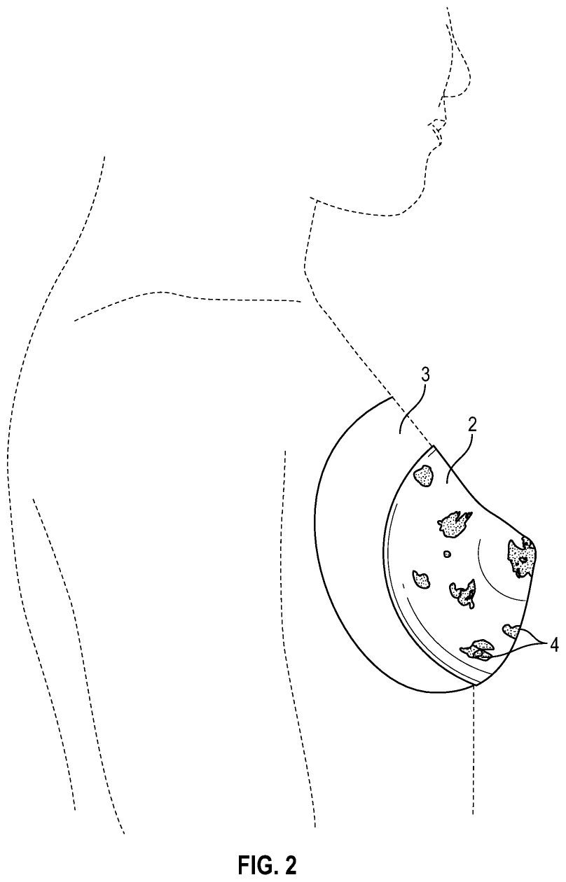

FIG. 2 shows the nipple cover 2 from the side, plus the area around the nipple cover that can be blended 3 and the unappealing or softer images 4 which are scattered throughout the nipple cover 2.

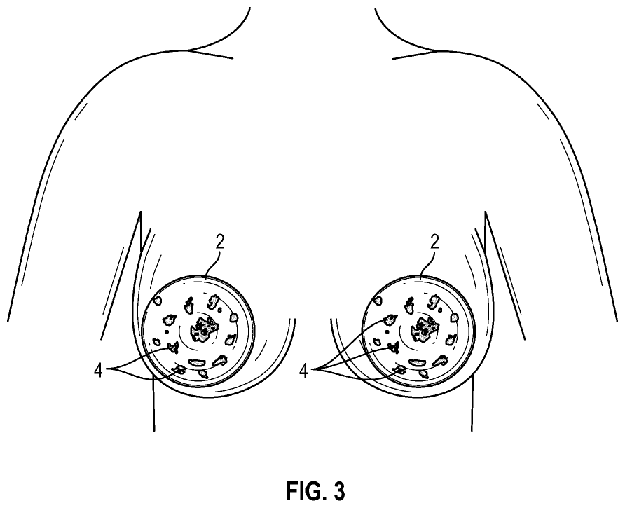

FIG. 3 shows the nipple covers 2 from the front with the unappealing or softer images images 4.

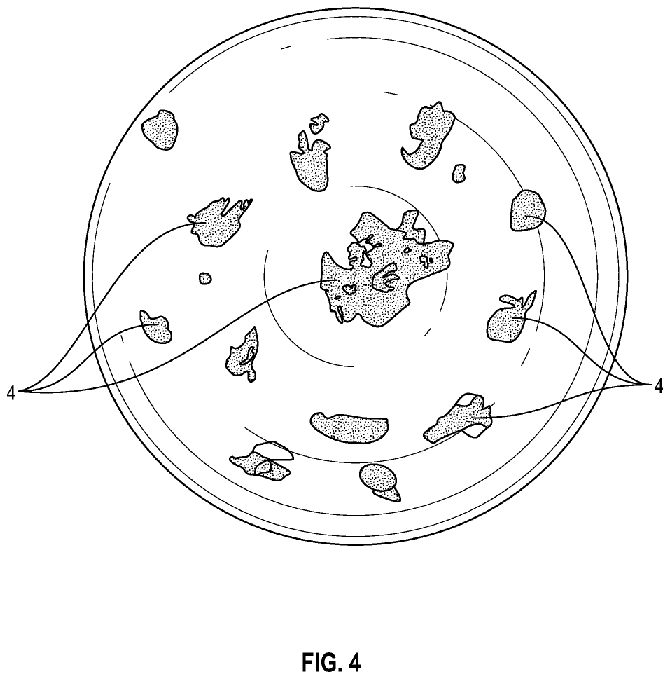

FIG. 4 shows the unappealing or softer images 4.

1. A method for weaning a child by restrict access to mom's breast through devices that make nursing to a child comprising:
a breast wrap to cover the nipples.
